(19) United States
(12) Patent Application Publication
(10) Pub. No.: US 2025/0348961 A1
(43) Pub. Date: Nov. 13, 2025

(54) ARRANGEMENT FOR ENABLING A NON-EXPERT TO DEVELOP AN EXPERT-LEVEL HOUSING REPORT BASED ON MULTIMEDIA CONTENT

(71) Applicant: Kaiizen Inc., Glendale, AZ (US)

(72) Inventors: Or AGASSI, Brooklyn, NY (US); Tov ARNESON, New York, NY (US)

(73) Assignee: Kaiizen Inc., Glendale, AZ (US)

(21) Appl. No.: 19/206,813

(22) Filed: May 13, 2025

Related U.S. Application Data
(60) Provisional application No. 63/646,211, filed on May 13, 2024.

(51) Int. Cl. G06Q 50/163; H04N 23/60

(52) U.S. Cl. CPC G06Q 50/163; H04N 23/64

(57) ABSTRACT

A method for generating a real-estate property (REP) assessment report comprising: a) generating a customized instruction instructing a user to capture at least a further multimedia content associated with the REP, wherein the instruction is generated based on a multimedia content received from a user device; b) transmitting, the customized instruction toward the user device; c) receiving, the at least a further multimedia content from the user device; d) when additional multimedia content is not required REP, developing the REP assessment report based upon received multimedia content; and e) when additional multimedia content is required to generate the REP assessment report, generating a subsequent customized instruction instructing the user to capture the additional multimedia content and repeating (b) through (e) using as the customized instruction the subsequent customized instruction and the additional multimedia content as the further multimedia content.

### CROSS REFERENCE TO RELATED APPLICATIONS

This application claims the benefit of U.S. Provisional Application No. 63/646,211 filed on May 13, 2024, the contents of which are incorporated herein by reference.

### TECHNICAL FIELD

The present disclosure relates generally to real-estate assessment tools, and more specifically to a enabling a non-expert to develop an expert-level housing report based on video.

### BACKGROUND

In the realm of real estate transactions, various types of property-related reports are prepared to assist in evaluating a property under consideration. These may include, but are not limited to, inspection reports, valuation reports, walkthrough reports, renovation reports, and scope of work documents. Such reports provide critical information regarding the condition, value, or work required for the property and play a pivotal role in decision-making processes by potential buyers, investors, contractors, or real estate professionals.

Typically, such reports are prepared by an expert e.g., qualified inspector, appraisers, contractor, and the like, who possesses the expertise and knowledge necessary to assess various aspects of the property, such as its structural integrity, mechanical systems, and renovation needs. Once the inspection is complete, the expert compiles his findings into a detailed report, which outlines any deficiencies, safety concerns, or maintenance issues discovered during the inspection process. This report provides valuable insights that enables a prospective buyer to make an informed decision about whether to proceed with the purchase, renegotiate the terms of the sale, or address any necessary repairs or upgrades.

However, while such reports offer valuable information for buyers, they also come with certain limitations and challenges. One of the primary drawbacks is the nontrivial cost associated with hiring an expert to conduct the inspection, which adds to the overall expenses involved in purchasing a property. Additionally, the need to schedule an inspection appointment with the expert can sometimes lead to delays in the home buying process.

It would therefore be advantageous to provide a solution that would overcome the challenges noted above.

### SUMMARY OF THE DISCLOSURE

A summary of several example embodiments of the disclosure follows. This summary is provided for the convenience of the reader to provide a basic understanding of such embodiments and does not wholly define the breadth of the disclosure. This summary is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “certain embodiments” may be used herein to refer to a single embodiment or multiple embodiments of the disclosure.

Certain embodiments disclosed herein include a method for generating a real-estate property (REP) assessment report by a computing system. The method comprises: a) generating, by the computing system, a customized instruction instructing a user to capture, using a user device, at least a further multimedia content associated with the REP, wherein the customized instruction is generated based on a multimedia content received from a user device; b) transmitting, from the computing system, the customized instruction toward the user device; c) receiving, at the computing system, the at least a further multimedia content from the user device; d) when additional multimedia content is not required by the computing system to develop a REP assessment report for the REP that reflects a current state of the REP, developing by the computing system, the REP assessment report for the REP that reflects the current state of the REP based upon all multimedia content received from the user device; and e) when additional multimedia content is required by the computing system to generate the REP assessment report for the REP that reflects the current state of the REP, generating by the computing system a subsequent customized instruction instructing the user to capture the additional multimedia content and repeating (b) through (e) using as the customized instruction the subsequent customized instruction and the additional multimedia content as the further multimedia content.

Certain embodiments disclosed herein include a method for generating a real-estate property (REP) assessment report by a computing system, comprising: a) generating, by the computing system, a plurality of customized instructions, each customized instruction being for instructing a respective one of a plurality of users to capture, using user devices that are associated with a respective one of the users, at least a further multimedia content associated with the REP, wherein each customized instruction is generated based on multimedia content received from each respective one the user devices; b) transmitting, from the computing system, each respective customized instruction toward a respective one of the user devices; c) receiving, at the computing system, each of the at least a further multimedia content from each of the user devices; d) when additional multimedia content is not required by the computing system to develop a REP assessment report for the REP that reflects a current state of the REP, developing by the computing system, the REP assessment report for the REP that reflects the current state of the REP based upon all multimedia content received from the user devices; and e) when additional multimedia content is required by the computing system to generate the REP assessment report for the REP that reflects the current state of the REP, generating by the computing system, at least one subsequent customized instruction instructing at least one of the users to capture the additional multimedia content and repeating (b) through (e) using (i) the customized instructions as the at least one subsequent customized instruction and (ii) the additional multimedia content as the further multimedia content.

Certain embodiments disclosed herein include a system for generating a real-estate property (REP) assessment report by a computing system, comprising: a processing circuitry; and a memory, the memory containing instructions that, when executed by the processing circuitry, configure the system to: a) generate, by the computing system, a customized instruction instructing a user to capture, using a user device, at least a further multimedia content associated with the REP, wherein the customized instruction is generated based on a multimedia content received from a user device; b) transmit, from the computing system, the customized instruction toward the user device; c) receive, at the computing system, the at least a further multimedia content from the user device; d) when additional multimedia content is not required by the computing system to develop a REP assessment report for the REP that reflects a current state of the REP, develop by the computing system, the REP assessment report for the REP that reflects the current state of the REP based upon all multimedia content received from the user device; and e) when additional multimedia content is required by the computing system to generate the REP assessment report for the REP that reflects the current state of the REP, generate by the computing system a subsequent customized instruction instructing the user to capture the additional multimedia content and repeating (b) through (e) using as the customized instruction the subsequent customized instruction and the additional multimedia content as the further multimedia content.

### BRIEF DESCRIPTION OF THE DRAWING

In the drawing:

FIG. 1 is a network diagram utilized to describe various disclosed embodiments.

FIG. 2 is a schematic diagram of a computing device utilized for generating a real-estate property (REP) assessment report according to an embodiment.

FIG. 3 is a flowchart describing a method for generating a real-estate property (REP) assessment report according to an embodiment.

FIG. 4 is a flowchart describing a method for generating training data set that is utilized for real-estate property (REP) assessment report generation according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

In accordance with the principles of the disclosure, a non-expert is assisted to develop an expert-level housing report based on multimedia content. To this end, a trained model is applied to a first multimedia content that is received from a user device of a user. An arrangement including the model is adapted to generate customized instructions that are given to the user to instruct the user as to what should be done to accurately capture the current status of the REP using the user device. A first customized instruction is generated that instructs the user to capture, using the user device, a second multimedia content associated with the REP. The second multimedia content is also received from the user device. Then, a REP assessment report is generated based on the first multimedia content and the second multimedia content for the REP, the generated report reflecting the current state of the REP. Before it can generate the assessment report, the arrangement may determine that that further multimedia content is required in order to be able to properly generate the REP assessment report. If such further multimedia content is required in order to properly generate the assessment report, a second customized instruction is generated that instructs the user to capture, using the user device further multimedia content associated with the REP, is generated.

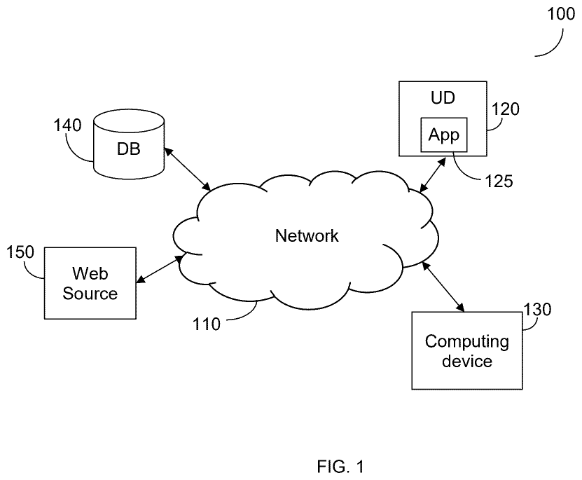

FIG. 1 is an illustrative network diagram 100 for use in describing various disclosed embodiments. Network diagram 100 shows a user device 120, a computing device 130, and a database 140 which are communicatively coupled via a network 110. The network 110 may be, but is not limited to, a wireless network, a cellular network, a wired network or combination thereof, such network being configured as, for example, a local area network (LAN), a wide area network (WAN), a metro area network (MAN), the Internet, the worldwide web (WWW), similar networks, and any combination thereof.

A user device 120 may be and conventional user device, for example, a personal computer (PC), a personal digital assistant (PDA), a mobile phone, a smart phone, a tablet computer, an electronic wearable device, e.g., glasses, a watch, etc., and other kinds of wired and mobile appliances, equipped with browsing, viewing, image or video capturing, storing, listening, filtering, and managing capabilities enabled as further discussed herein below.

Each user device 120 may further include a software application (App) 125 installed thereon. The application 125 may be pre-installed on the user device 120 or downloaded thereto. In one embodiment, the application 125 is a web-browser.

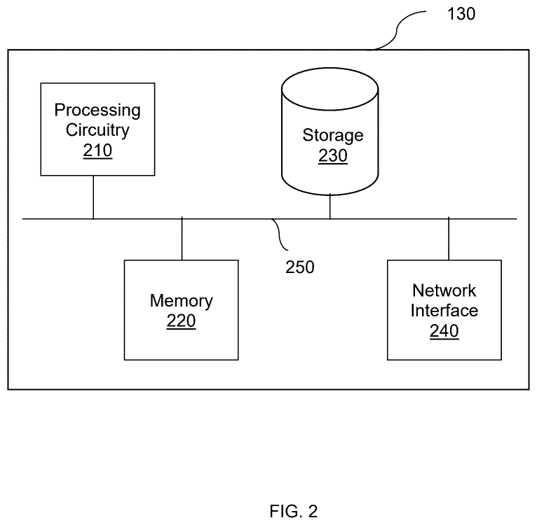

The computing device 130 is coupled, over the network 110, to each user device 120 and can communicate therewith using the application 125 via the network 110. In an embodiment, the computing device 130 may be a physical device as illustrated in FIG. 2. In another embodiment, the computing device 130 may be a virtual machine operable in a cloud computing platform. It should be noted that only one user device 120 and one application 125 are described herein merely for the sake of simplicity. However, the embodiments disclosed herein are not so limited but rather may be applicable to a plurality of user devices that can communicate with the computing device 130 via the network 110.

As further discussed herein below in detail, the computing device 130 is configured to receive user inputs and generate customized instructions allowing the user to capture the current state of the real-estate property (REP) easily and accurately, as further discussed herein.

The database 140 is configured to store data and metadata related to REPs, multimedia content, data extracted from regulatory data sources, public data source and/or tax authorities, geographic information systems (GISs), and more. In the embodiment shown FIG. 1, the computing device 130 communicates with the database 140 through the network 110.

One or more web sources 150 may be communicatively coupled to the computing device 130 via the network 110. The web sources may be for example, a website, a database, and the like. The web sources may include data regarding REPs.

It should be noted that the embodiments described herein are not limited to the particular configuration illustrated in FIG. 1 and that different configurations may be utilized without departing from the scope of the disclosure. Also, in some implementations, any or all of the components shown in FIG. 1 may communicate directly rather than through a network.

FIG. 2 is an illustrative block diagram 130 of a computing device 130 used for generating a real-estate property (REP) assessment report, according to an embodiment.

The computing device 130 includes a processing circuitry 210 coupled to a memory 220, a storage 230, and a network interface 240. In an embodiment, the components of the computing device 130 may be communicatively connected via a bus 250.

The processing circuitry 210 may be realized as one or more hardware logic components and/or circuits. Types of hardware logic components that can be used may be field programmable gate arrays (FPGAs), application-specific integrated circuits (ASICs), Application-specific standard products (ASSPs), system-on-a-chip systems (SOCs), GPUs, general-purpose microprocessors, microcontrollers, digital signal processors (DSPs), and the like, or any other hardware logic components that can perform calculations or other manipulations of information.

The memory 220 may be volatile, e.g., RAM, etc., non-volatile, e.g., ROM, flash memory, etc., or a combination thereof. In one embodiment, the memory 220 is configured to store software. Software shall be construed broadly to mean any type of instructions, whether referred to as software, firmware, middleware, microcode, hardware description language, or otherwise. Instructions may include code, e.g., in source code format, binary code format, executable code format, or any other suitable format of code. The instructions, when executed by the processing circuitry 210, cause the processing circuitry 210 to perform the various processes described herein.

The storage 230 may be magnetic storage, optical storage, and the like, and may be realized, for example, as flash memory or any other medium which can be used to store the desired information. In one configuration, computer readable instructions to implement one or more embodiments disclosed herein may be stored in the storage 230.

The network interface 240 allows the computing device 130 to communicate with the user devices, web sources and database of FIG. 1.

It should be understood that the embodiments described herein are not limited to the specific architecture illustrated in FIG. 2, and other architectures may be equally used without departing from the scope of the disclosed embodiments.

In an embodiment, the computing device 130 receives a first multimedia content from a user device, e.g., the user device 120. The first multimedia content may include for example audio recording, one or more images, video, and the like, related to a REP in which the user is located. The first multimedia content may be supplied by a user using the user's user device 120. For example, the first multimedia content may include a message, received from the user including an image of a kitchen inside the REP, a video showing the roof, an audio recording of the user with a partial description of the REP, and the like.

It should be noted that the multimedia content may include information that is not necessarily directly indicative of the condition of the REP. The system is designed to determine the state of the property. To that end, it may be beneficial to capture content such as the surrounding street view, neighboring houses, or other contextual elements, as these may influence the property's assessed value and affect the system's subsequent data requests. Accordingly, even seemingly unrelated multimedia inputs may be used by the system to better understand the property's environment and tailor its future instructions.

In addition, the purpose of obtaining such potentially unrelated multimedia content may be to enable the system to better guide the user through an iterative interaction process for obtaining necessary information related to the REP. As such, even when some inputs are not directly useful for assessing the REP, they can inform the system about the user's behavior, comprehension level, and context, allowing the system to generate better-targeted instructions and ultimately obtain the necessary REP-related data.

To this end, the computing device 130 is configured to generate and present to the user, via the user device 120, one or more outputs, which may be multimedia outputs, with an aim to eventually cause the user to accurately capture the current status of the REP. For example, the user may be presented with audible instructions or a video may be displayed on the user device showing the user a representative version of what the user should do next. The outputs generated by the computing device 130 may include answers to questions asked by the user, recommendations, and the like.

In an embodiment, at least one model, e.g., a machine learning model, a large language model (LLM), a computer vision model, and the like, is applied to the multimedia content received from the user device 120. The model is adapted to generate a plurality of customized instructions for the user to instruct the user as to how to accurately capture the current status of the REP using the user device 120. The model may be a supervised model, unsupervised model, semi-supervised model, reinforcement learning model, and the like.

In an embodiment, the model is trained using a labeled training data set that includes pre-inspection data and annotated multimedia content captured from a variety of real-estate properties. The inputs to the model may include images, videos, and optionally audio. Based on these inputs, the model is configured to output detailed customized instructions for the user. These outputs may include prompts such as: “please take a photo from a different angle,” “zoom in on the window lock,” or “record the sound of the water flow.” The model may further analyze visual cues, e.g., lighting, angles, and obstructions, to identify gaps in the captured content and suggest targeted next actions accordingly.

Prior to applying the model to the first multimedia content that is received from the user device 120, the model is trained using a training data set. The training data set may be retrieved from one or more sources e.g., the web source 150 which includes sources like a website, a database, a cloud database, and the like. The training data set may include pre-inspection data associated with the REP. Pre-inspection data refers to data that can be obtained without having an assessment report. For example, pre-inspection data may include global navigation satellite system (GNSS) data, e.g., coordinates of the REP, that can be used for guiding the user throughout the REP, images and videos of the REP extracted from a website, size of the REP that may be extracted from a governmental database, data related to the area in which the REP is located, and so on.

In the context of supervised learning, as noted above, the training dataset is constructed by associating pre-inspection multimedia content with labeled outputs. Labels may be created manually, e.g., by experts or crowdsourced by presenting multimedia content to users and receiving structured inputs about the REP features, e.g., room type, material condition, presence of damage, etc., These labeled examples allow the model to learn to associate specific visual or textual patterns with meaningful property attributes or instructions for obtaining the necessary information. In the context of unsupervised learning, the training data may be clustered based on inherent patterns within the multimedia content itself, such as structural similarities, visual features, or spatial configurations of REPs. Such clustering may help identify common property layouts or detect atypical property elements. The unsupervised model can support the identification of relevant features within new multimedia inputs or be used to pre-train downstream supervised models with more efficient representations of the property data.

In an embodiment, during operation, upon receiving the first multimedia content as an input, the model generates a first customized instruction and presents it to the user via the user device 120. The instruction is typically designed to guide the user in capturing additional multimedia content that is more relevant or of higher quality. According to another embodiment, the computing device 120 generates a first output which is not necessarily an instruction. That is, the first output may be for example, message or a sequence of messages which include for example, a greeting, a question, a greeting followed by an instruction instructing the user to capture additional image of the kitchen from a different angle, and the like. For instance, a question may be phrased as an instruction, e.g., “please answer the following question before continuing”, and greetings may be used to facilitate smoother interaction or increase user engagement, especially in cases where the interaction is prolonged or involves multiple steps. However, in most cases, the primary form of output remains an instruction targeted at collecting additional or improved multimedia content.

As mentioned above, the first multimedia content that is received from the user device 120 may not necessarily include data that is related to the REP and therefore the trained model is adapted to generate outputs which refer to the multimedia content provided by the user with an aim to encourage the user to eventually capture the necessary data to capture the current state of the REP.

In order to generate customized instructions for the user which allow the user to accurately capture the current status of the REP, the computing device 130 stores the user-supplied inputs, i.e., the multimedia content provided by the user via the user device, and supplies them to the model. The model in response, updates its outputs continuously with respect to the user inputs, i.e., multimedia content. To that end the computing device 130 may use one or more models to parse natural language, analyze images and video clips captured by the user device 120, and the like.

The model processes the received multimedia content by analyzing it such as, for example, its visual and/or audio features, to determine whether the content sufficiently reflects the current state of the REP or whether additional data is required. For example, upon detecting an image of a kitchen that includes an oven, the model may identify that the oven door is closed and generate a customized instruction asking the user to open the oven and capture a close-up image of the appliance's data plate. The model may also analyze image quality parameters such as resolution, brightness, and framing to decide whether a clearer or better-angled image is necessary. The system evaluates the completeness and relevance of the multimedia content and generates specific instructions designed to improve the quality and coverage of the captured data regarding the REP when necessary based on the evaluation.

In an embodiment, a large language model (LLM) is used for predicting the user's future input or feedback to an instruction, request, or any other output generated by the computing device 130. By predicting the user's future input or feedback, the computing device 130 may customize its output, e.g., instructions, that is presented to the user.

The instruction given to the user may be calibrated to one or more characteristics of the user. For example, in one embodiment, the level of detail and specificity provided by an instruction may be based on a determination of the user's knowledge level. Accordingly, the user's knowledge level may be inferred based on their responses and behavior throughout the interaction. For example, if the user consistently captures high-quality multimedia content with minimal need for follow-up corrections, the system may infer a higher level of knowledge or competence. Conversely, if the user submits repeated submission of blurry or irrelevant images or makes frequent requests for clarification, this may indicate that the user has limited knowledge or competence. The model may further analyze linguistic patterns in the user's textual or audio responses, e.g., use of technical terminology or sentence complexity, to support or confirm this determination. Based on such assessment, which may be ongoing or otherwise dynamic, the system can adjust the instructions given to the user to make them more detailed, simplified, or structured as needed.

It should be noted that beyond assessing the user's knowledge level, the system may also dynamically adapt its operation based on various characteristics inferred from the user's interaction. These may include the user's responsiveness, preferred communication modality, e.g., text vs. voice, pace of engagement, or tendency to follow instructions accurately. By analyzing patterns in the user's inputs and interaction history, the system can personalize not only the content and complexity of instructions, but also the timing, tone, format of its outputs such as instructions, and the like. This adaptability enables a more efficient and user-friendly process, improving the likelihood of getting the user to capture the high-quality multimedia content needed to generate the REP assessment report. For example, in one embodiment, the instructions given to a user may employ a louder volume than would otherwise be used upon determination that the user does not hear well. As yet a further example, an instruction may be such so as to be perceived by the user as being cynical, being kind, etc., In response to a determination of the character of the user or a mood of the user.

In an embodiment, the computing device 130 generates, using the trained model, the first customized instruction instructing the user to capture, using the user device 120, at least a second multimedia content associated with the REP. The second multimedia content is multimedia content that is requested that the user supply in order to get additional data or better-quality data about the REP. In an embodiment, the computing device 130 receives the second multimedia content from the user device 120 in response to the first instruction.

Customized instructions are the dynamically generated directives that are specifically tailored in to motivate the user to provide input required to generate the report and are based on the point in the collection process the project is at and, other than at the beginning of the collection, at least one multimedia content already received from the user. Advantageously, rather than relying on a static script of predetermined steps, the computing device 130 is able to analyze inputs received from the user via the user device, e.g., image content, as well as image angle, quality, metadata, in order to generate instructions that are designed to cause the user to collect what is missing, unclear, or incomplete in the current state of the available and collected information.

As noted above, in addition to analyzing the content collected by the user itself, the computing device 130 may also consider the user's interaction patterns with the system, including prior responses, preferences, and inferred limitations, e.g., visual framing difficulties or slower response times. This enables the model to further refine the customized instructions to match the user's capabilities and communication style.

For example, if a received image of a bathroom requested by the system does not include a clear view of the sink, a customized instruction may be phrased differently depending on the user. For a user who consistently provides incomplete or unclear content and tends to ignore prior instructions, the computing device 130 may respond with a more direct or even slightly cynical tone—e.g., “Let's try again. This time, make sure the sink is actually visible.” In contrast, for a user who generally cooperates and submits high-quality inputs, the instruction to collect the same amage might be framed more positively, e.g., “Thanks! Could you please take one more photo of the sink area from above so we can capture all relevant details?”

The first customized instruction may include one or more multimedia content, e.g., text, audio, image, video, a combination thereof, and the like, to instruct, or aid in instructing, the user to provide multimedia content associated with the REP such that an accurate and reliable current state of the REP can be captured. In some embodiments, the instruction may include a visual example or illustration, e.g., an image or a short illustrative video clip, demonstrating the desired framing, angle, or object to capture. This can be especially useful when guiding users with limited technical experience or limited photographic experience, as a visual reference reduces ambiguity and helps align the user's input with the system's requirements.

It should be noted that multiple users may use their user devices, e.g., the user device 120, to capture multimedia content in the same REP at the same time or separately. In such cases, the computing device 130 may associate each piece of multimedia content with metadata therefor, e.g., user ID, time, location within the property, to ensure proper organization and context. Such multi-user collaboration is particularly useful in scenarios where the property owner, real estate agent, or maintenance personnel each contribute multimedia content with different perspectives. Unlike traditional inspections performed solely by a professional inspector, this approach allows distributed and possibly remote documentation, which may reduce delays and enable more comprehensive coverage of the property. The system may handle asynchronous inputs and may dynamically issue instructions to different users based on their proximity to specific areas of the REP or based on their previous contributions. For example, if the system detects that one user is located on the ground floor while another is on the upper floor, the first user may be instructed to capture images of the entrance and kitchen while the second user may receive instructions to document the upstairs bedrooms. Additionally, if one user has already provided a high-quality set of images of the living room, the system may direct another user to cover a different area that has not yet been documented. This may all be done dynamically and without requiring direct coordination between the users.

In an embodiment, the computing device 130 may keep generating additional customized instructions and receive user feedback, i.e., multimedia content supplied by the user, until the computing device 130 determines that sufficient information, e.g., the amount and quality of the gathered multimedia content is above a predefined threshold value, i.e., sufficient to base a certain portion of the report thereon. Upon receiving the second multimedia content, the second multimedia content is supplied by the computing device 130 into the model as an input.

In an embodiment, when sufficient information, e.g., the amount and quality of the gathered multimedia content is above a predefined threshold value, the computing device 130 generates a REP assessment report which reflects the current state of the REP. The REP assessment report is generated based on the first multimedia content and at least the second multimedia content.

It should be noted that although the multimedia content received from each of one or more user devices may be processed and analyzed by the computing device 130, and as such the REP assessment report is actually based on all of the received multimedia content. Nevertheless, the REP assessment report generated may ultimately incorporate or reflect only a subset, i.e., less that all, of the received multimedia content. To this end, the computing device 130 may determine, based on relevance, quality, redundancy, or completeness, which portions of the multimedia content are sufficient and most suitable for incorporation into an accurate and meaningful REP assessment report that is generated for use by the user. This allows the computing device 130 to incorporate into the REP assessment report high-value inputs while not including therein unnecessary or lower-quality content.

The REP assessment report is an electronic document which reflects the current state of different sections of the REP. The assessment report can be used for indicating faults or issues that may exist within the REP, project the REP current value, indicate any necessary improvements, predict the length and cost of improving or renovating the REP, and the like. According to further embodiment, upon generating the REP assessment report which reflects the current state of the entire REP, the computing device 130 generates recommendations for repairing different sections of the REP, improving those sections, increasing the REP's value by repairing, renovating removing or adding different items, and so on. According to another embodiment, the recommendations may be generated by the computing device 130 without, or prior to, completing the REP assessment report. A recommendation generated by the computing device 130 may indicate, for example, a specific portion of the REP, a specific task that should be performed with respect to the specific portion, the estimated contribution of the performed task to the REP's value, and the like. For example, based on the REP assessment report, it is determined that the kitchen's floor is ruined and therefore should be replaced. According to the same example, a recommendation may include suggesting the user to cover the ceramic tiles in the kitchen with parquet floor for achieving several goals such as, save precious time of removing the tiles and increase REP's value by USD 20,000 by doing so. The projected contribution to the REP's value may be determined based on, for example, comparison to renovations made and sale price of similar REPs. Similar REPs are REP having similar characteristics to the respective REP. For example, same area, similar size, and the like.

In an embodiment, based on the generated REP assessment report, the computing device 130 may access one or more external or internal data sources, including product catalogs, renovation material databases, labor rate references, or construction schedule templates. Thus, the computing device 130 may generate additional outputs, including but not limited to: (i) a renovation scope, (ii) a scope of work document, (iii) a shopping cart of suggested materials and associated quantities, (iv) a purchase order with the suggested materials, (v) a renovation schedule or project timeline, and (vi) one or more calculations of return on investment (ROI) subject to completion of one or more proposed renovations. These outputs may be combined to form a comprehensive renovation plan, tailored to the specific state and characteristics of the REP as determined from the REP assessment report.

In an embodiment, upon determining that further multimedia content is required for generating the REP assessment report, a second customized instruction instructing the user to capture further multimedia content associated with the REP, may generate. It should be noted that the customized instructions, e.g., first, second, etc., generated by the computing device 130 are based on the multimedia content, e.g., image, video, audio, etc., previously provided by the user using the user device 120. That is, the customized instruction may be generated based on the content and/or quality of an image of the living room previously provided by the user, an analysis of the text of a text message previously provided by the user, and so on.

According to one embodiment, the computing device 130 determines if further multimedia content is required based on other data that is available or was extracted about the REP, e.g., number of rooms, and/or the multimedia content provided by the user.

According to another embodiment, the multimedia content received from the user device 120 is analyzed using for example, computer vision models, LLM, and the like, regardless of the content that was requested by the computing device 130. For example, although the computing device 130 sends to the user device 120 an instruction specifically to provide a video of the countertop, the video received from the user device 120 may also include a high-quality video of the entire kitchen. Thus, the computing device 130 may consider the other elements that appear in the video, e.g., refrigerator, lighting, ceiling condition, floor condition, and so on, and thus may not bother the user with further requests for elements that were detected in the multimedia content that was captured already provided they are of sufficient quality to meet the needs of computing device 130 with regard to such elements.

According to another embodiment, upon identification of one or more appliances in the REP, the computing device 130 generates and sends an instruction, via the user device 120, for the user to provide technical details regarding a specific appliance. Providing the technical details may be achieved for example, by first instructing the user to capture, using device 120, an image of the data plate or sticker, i.e., an identification tag, that is attached to the appliance. Then, the identification tag can be used to retrieve technical details about the appliance from, for example, a web source. Thereafter, the technical details of the REP's appliances may be used for forming the REP assessment report.

In an embodiment, based on the REP assessment report, which is in turn based on the captured multimedia content, the computing device 130 may generate a projected sale price of the REP. The projected sale price may refer to the current state of the REP or to a future, post renovation, state of the REP. As noted herein, faults or issues that may exist within the REP may be detected by analyzing the multimedia content received from the user device 120. Thus, a required renovation process, its length and cost may be indicated and facilitate determination of a projected sale price.

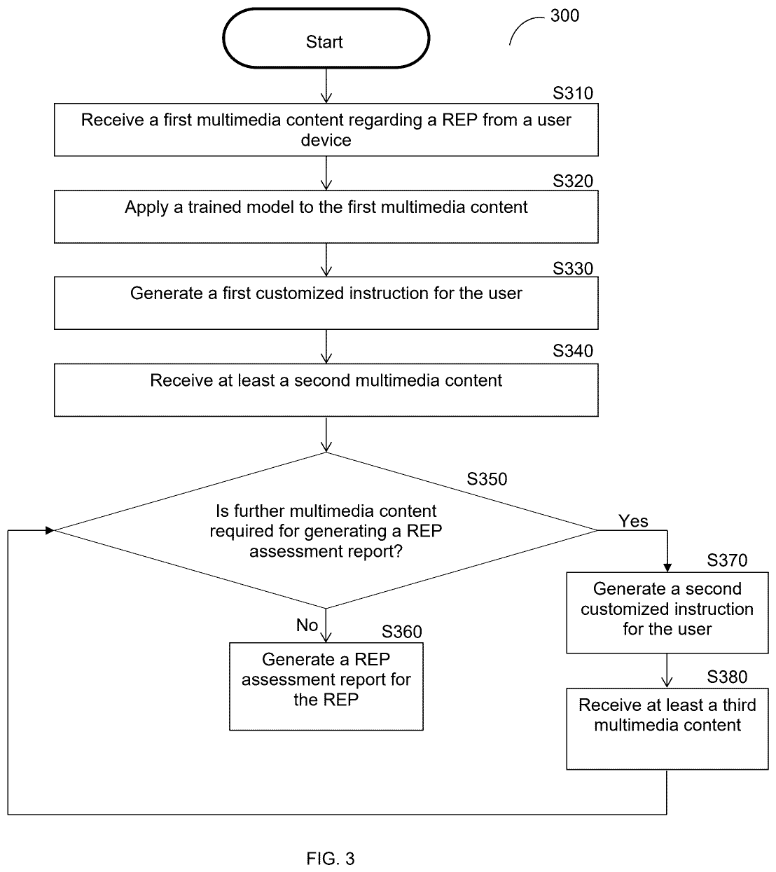

FIG. 3 is an example flowchart 300 illustrating a method for generating a real-estate property (REP) assessment report according to an embodiment. In an embodiment, the method is performed by the computing device 130, FIG. 1.

At S310, a first multimedia content is received from a user device, e.g., the user device 120 of FIG. 1. The first multimedia content may include for example, images, video, audio recording, and the like, related to a REP at which the user and its user device are located.

At S320, the multimedia content received from the user device is supplied to at least one trained model. The model facilitates the generating of customized instructions.

At S330, based on the multimedia content received from the user device, a first customized instruction informing the user how to accurately capture the current status of the REP using the user device is generated. The customized instruction tells or shows the user what to do so that the user can record at least one section of the REP in an accurate and reliable manner. The first customized instruction is then sent to the user device from which it is presented to the user.

At S340, at least a second multimedia content is received from the user device, e.g., in response to the user following, or attempting to follow, the customized instruction.

At S350, it is determined whether further multimedia content is required to be supplied by the user to enable generating the REP assessment report and if so, execution continues with S370; otherwise, execution continues with S360.

At S370, at least a second customized instruction is generated for the user. The second customized instruction, like the first customized instruction, tells or shows the user what to do so that the user can provided further multimedia content in an accurate and reliable manner. The customized instruction is then sent to the user device.

At S380, at least a third multimedia content is received from the user device.

At S360, upon determination that the amount and quality of the multimedia content received from the user device is above a threshold value, a REP assessment report is generated. The generated assessment report may then be sent to one or more devices, e.g., the user device 120 of FIG. 1.

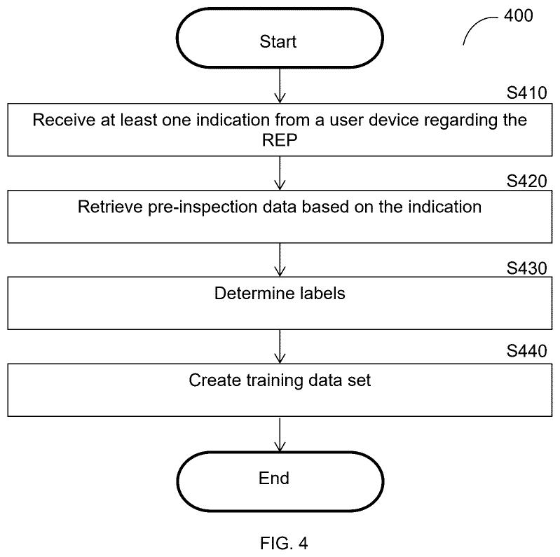

FIG. 4 is an example flowchart 400 illustrating a method for generating a training data set that is utilized for real-estate property (REP) assessment report generation according to an embodiment. In an embodiment, the method is performed by the computing device 130, FIG. 1.

At S410, at least one indication is received from a user device of a user that is associated with an REP that is to be used as one of the bases for training. For example, the user may be located in proximity to the REP's front door and the indication may be a GNSS signal received from the user device upon initiating a designated application, e.g., the application 125, on the user device, e.g. the user device 120.

At S420, pre-inspection data is retrieved from one or more sources, e.g., the web sources 150 of FIG. 1. The pre-inspection data refers to data that can be obtained without having an assessment report. For example, pre-inspection data may include images and videos of the REP extracted from a website, size of the REP that may be extracted from a governmental database, and so on.

At S430, a training data set is created. In an embodiment, the training data set includes pre-inspection data, REP training feature identifiers, and training labels indicating REP features. The labels may be created by providing REP data to a user and receiving inputs indicating information related to the REP features, e.g., in the manner described hereinabove.

The pre-inspection data includes data related to the REP such as, multimedia content, text, and so on. As a non-limiting example, the pre-inspection data may include among others, a digital image showing the frontage of the REP including the doors and windows, a video showing the living room, a textual description of the property, and so on.

The REP training feature identifiers uniquely identify the REP's exterior and interior features and may include, but are not limited to, country, region, street address, zip code, floor identifier, apartment identifier, square footage, number of rooms, floor condition, roof condition, walls color, windows brand, appliances brand, and so on.

Labels indicating the REP features may be created by an expert, or by providing multimedia content to a user and receiving inputs indicating information related to the REP features.

At S440, a training data set is created using the determined labels. The training data set is then utilized for training the model discusses herein.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for generating a real-estate property (REP) assessment report by a computing system, comprising:
a) generating, by the computing system, a customized instruction instructing a user to capture, using a user device, at least a further multimedia content associated with the REP, wherein the customized instruction is generated based on a multimedia content received from a user device;
b) transmitting, from the computing system, the customized instruction toward the user device;
c) receiving, at the computing system, the at least a further multimedia content from the user device;
d) when additional multimedia content is not required by the computing system to develop a REP assessment report for the REP that reflects a current state of the REP, developing by the computing system, the REP assessment report for the REP that reflects the current state of the REP based upon all multimedia content received from the user device; and
e) when additional multimedia content is required by the computing system to generate the REP assessment report for the REP that reflects the current state of the REP, generating by the computing system a subsequent customized instruction instructing the user to capture the additional multimedia content and repeating (b) through (e) using as the customized instruction the subsequent customized instruction and the additional multimedia content as the further multimedia content.

2. The method of claim 1, wherein generating any of the customized instruction and the subsequent customized instruction further comprises supplying at least a last received multimedia content from the user device to a trained model that is adapted to generate a customized instruction for the user directing the user to capture multimedia content indicative of a further aspect of the current state of the REP using the user device.

3. The method of claim 2, wherein the trained model is further adapted to determine when additional multimedia content is not required by the computing system to develop the REP assessment report for the REP.

4. The method of claim 2, wherein the trained model is further adapted to develop the REP assessment report for the REP.

5. The method of claim 2, wherein the trained model is further adapted to generate outputs, other than instructions, allowing management of interactions with the user.

6. The method of claim 2, wherein training the model comprises obtaining at least one training data set.

7. The method of claim 2, wherein training the model comprises:
receiving, from the user device, at least one indication regarding the REP; and
supplying the indication to the model.

8. The method of claim 2, wherein training the model further comprises:
obtaining pre-inspection data about the REP.

9. A method for generating a real-estate property (REP) assessment report by a computing system, comprising:
a) generating, by the computing system, a plurality of customized instructions, each customized instruction being for instructing a respective one of a plurality of users to capture, using user devices that are associated with a respective one of the users, at least a further multimedia content associated with the REP, wherein each customized instruction is generated based on multimedia content received from each respective one the user devices;
b) transmitting, from the computing system, each respective customized instruction toward a respective one of the user devices;
c) receiving, at the computing system, each of the at least a further multimedia content from each of the user devices;
d) when additional multimedia content is not required by the computing system to develop a REP assessment report for the REP that reflects a current state of the REP, developing by the computing system, the REP assessment report for the REP that reflects the current state of the REP based upon all multimedia content received from the user devices; and
e) when additional multimedia content is required by the computing system to generate the REP assessment report for the REP that reflects the current state of the REP, generating by the computing system, at least one subsequent customized instruction instructing at least one of the users to capture the additional multimedia content and repeating (b) through (e) using (i) the customized instructions as the at least one subsequent customized instruction and (ii) the additional multimedia content as the further multimedia content.

10. The method of claim 9, wherein the at least one subsequent customized instruction is a plurality of subsequent customized instructions each of the plurality of subsequent customized instructions being for a respective one of the users to perform, and wherein instructing at least one of the users to capture the additional multimedia content instructs at least two of the users to capture respective additional multimedia content.

11. The method of claim 10, wherein generating any of the customized instructions and the subsequent customized instructions further comprises supplying at least a last received multimedia content from each of the user devices to a trained model that is adapted to generate a customized instruction for each of the plurality of users directing each of the plurality of users to capture multimedia content indicative of a further aspect of the current state of the REP using the respective user devices.

12. A system for generating a real-estate property (REP) assessment report by a computing system, comprising:
a processing circuitry; and
a memory, the memory containing instructions that, when executed by the processing circuitry, configure the system to:
a) generate, by the computing system, a customized instruction instructing a user to capture, using a user device, at least a further multimedia content associated with the REP, wherein the customized instruction is generated based on a multimedia content received from a user device;
b) transmit, from the computing system, the customized instruction toward the user device;
c) receive, at the computing system, the at least a further multimedia content from the user device;
d) when additional multimedia content is not required by the computing system to develop a REP assessment report for the REP that reflects a current state of the REP, develop by the computing system, the REP assessment report for the REP that reflects the current state of the REP based upon all multimedia content received from the user device; and
e) when additional multimedia content is required by the computing system to generate the REP assessment report for the REP that reflects the current state of the REP, generate by the computing system a subsequent customized instruction instructing the user to capture the additional multimedia content and repeating (b) through (e) using as the customized instruction the subsequent customized instruction and the additional multimedia content as the further multimedia content.

13. The system of claim 12, wherein the system is further configured to supply at least a last received multimedia content from the user device to a trained model that is adapted to generate a customized instruction for the user directing the user to capture multimedia content indicative of a further aspect of the current state of the REP using the user device.

14. The system of claim 13, wherein the trained model is further adapted to determine when additional multimedia content is not required by the computing system to develop the REP assessment report for the REP.

15. The system of claim 13, wherein the trained model is further adapted to develop the REP assessment report for the REP.

16. The system of claim 13, wherein the trained model is further adapted to generate outputs, other than instructions, allowing management of interactions with the user.

17. The system of claim 13, where the system is further configured to obtain at least one training data set when training the model.

18. The system of claim 13, when training the model, is further configured to:
receive, from the user device, at least one indication regarding the REP; and
supply the indication to the model.

19. The system of claim 13, when training the model, is further configured to:
obtain pre-inspection data about the REP.
